(19) United States
(12) Patent Application Publication
(10) Pub. No.: US 2020/0044582 A1
(43) Pub. Date: Feb. 6, 2020

(54) METHOD FOR OPERATION OF AN ELECTROMECHANICAL MOTOR AND YARIMOV MOTOR

(71) Applicant: Marat Otellovich YARIMOV, selo Starosubhangulovo (RU)

(72) Inventor: Marat Otellovich YARIMOV, selo Starosubhangulovo (RU)

(21) Appl. No.: 16/480,823

(22) PCT Filed: Mar. 6, 2018
(86) PCT No.: PCT/RU2018/000140

§ 371 Date: Jul. 25, 2019

(30) Foreign Application Priority Data
Apr. 26, 2017 (RU) 2017114828

(51) Int. Cl. H02N 2/10; H02K 99/00

(52) U.S. Cl. CPC H02N 2/10; H02K 99/20

(57) ABSTRACT

The invention relates to power engineering and to power generation as a whole, in the field of electrical machines for converting electrical energy into mechanical energy or vice versa, and can be used in many spheres of human activity. In order to increase the efficiency and effectiveness of converting electrical energy into mechanical energy or vice versa and to expand additional functional capabilities, the primary Newtonian laws of mechanics and the law of conservation of energy are fulfilled, and conformity with the International Standard Unit of measurement for work is provided. A previously unknown method for operating electromechanical motors and electromechanical machines is proposed. The new method for operating an electromechanical motor and the motor make it possible to achieve the actual energy properties of electromechanical machines. The work performed or the power generated by the proposed invention is always higher than in the prior art.

### CROSS-REFERENCE TO RELATED APPLICATIONS

The present patent application is National stage application from PCT application PCT/RU2018/000140 filed Mar. 6, 2018, which claims priority to Russian patent application RU2017114828 filed on Apr. 26, 2017, currently issued as a patent, all of which incorporated herein in their entirety.

### FIELD OF INVENTION

The invention relates to power engineering and to power generation as a whole, in the field of electrical machines for converting electrical energy into mechanical energy or vice versa, and can be used in the energy industry, in industry, agriculture, forestry and public utilities, as well as in other spheres of human activity.

### BACKGROUND

The prior art (1) discloses means of operation of electric motors and devices from almost two centuries ago. State-of-the-art, as is seen from (2)-(5), stays the same, has not undergone any changes, and still has a low efficiency coefficient and effectiveness, does not provide quantification for the values of work or horsepower of the dynamic components of moving and rotating masses of, e.g. a rotor, which contradicts a fundamental law of nature, the law of conservation of mechanical energy (6). For this reason, the physical processes in all the known methods and devices do not correspond with the practical experience and actual properties of the values measured (work, horsepower), and are speculative.

For example, according to information source (2) on pages 267, 271, an energy diagram cannot reveal where excessive electric energy goes during the electromechanical motor acceleration; where the part of the energy it converted into is (since by virtue of the law of conservation of energy it cannot disappear without a trace). According to source (3), page 213, the efficiency coefficient of the known methods for operating an electromechanical motor or electromechanical machine is determined much the same as the efficiency coefficient of electric transformers which do not have rotating rotors at all. The fact confirms that the known operating principle of electromechanical motors with rotating rotors differs little from electric transformers in which the mechanical component of the rotor movement is not provided for. This is inappropriate since inherently the two are essentially different devices. In well-known (1)-(5) methods for operating electromechanical motors and devices for their performance, the component value of mechanical energy is absent and is not involved in operating or in their developed power, which contradicts the fundamental law of conservation of energy and cannot be applied in practice. In such a case, unfounded statements are made on the conversion of electrical energy into mechanical energy while the mechanical component is absent. Where, in such a case, is the component?

The well-known methods and devices prevent widespread application of energy-saving technologies with new, enhanced, and nonconventional functional capabilities in economy as a whole; they also do not provide application of the Newton laws of mechanics (7).

### SUMMARY OF THE INVENTION

The principle of electromechanical motor. The technical and technological result is achieved when in the start-up period mechanical energy obtained by the rotor speeding-up is accumulated; or when the rotor's rotational movement is accelerated in advance. Then the accumulated mechanical energy as the main component is quantified and applied; the energy is directly operated in the steady state mode; besides, another work component is performed from electric current the steady state nominal mode while the total mechanical work of the motor is performed and obtained in the amount equal to the sum of the component values determined by the mathematical expression:

Atot=|Ad|+|Ae| [1]

where Atot is the total quantitative work of the electromechanical motor in conversion of electrical energy into mechanical energy;
|Ad| is the component value of work from the accumulated energy of the rotor's rotational movement;
Ae is the component value of work from electric current in the steady state mode of the motor.

For convenience, taking into account the traditional approach, we transpose formula [1] expressing it through power and dividing both parts by time t. We get power expression:

Ptot=|Pd|+Pe [2].

where Ptot is the total power developed by the electromechanical motor in numerical terms;
|Pd| is the component value of power from the accumulated energy of the rotor's rotational movement;
Pe is the component value of power of the electromechanical motor in the nominal or steady state mode.

The well-known methods for operation of electrical motors and their devices do not have the main mechanical component expressed quantitatively and qualitatively, which contradicts the law of conservation of mechanical energy from [6], and thus they are not industrially applicable. Alternatively, the stator can rotate while the rotor is immobile.

The equation of motion [5.20] of the electrical motor or electrical machines as a whole on page 195 (4) describes, and also scientifically and technically only proves the physical process of acceleration or accelerated rotation of the rotor in the start-up period of time. Equations and expressions [1] and [2] alone reflect and describe the mechanical processes occurring in the proposed methods for operation of electrical motors and devices themselves in the nominal or steady state mode. For example, as is seen from Fig presenting an energy diagram of the operation of the author's motor, if the working motor Ae=0 is disconnected from the electrical network, then its rotor goes on rotating by inertia for a long time td. until it stops due to friction and various losses. This categorically proves and confirms that along with Ae—the rotational force of the rotor associated with the interaction of electrical current in windings and the magnetic field of the motor in the steady state mode, work Ad—the motion of the rotor with mass m and inertia moment J in modulus—is simultaneously and constantly present.

The start-up of the electromechanical motor in FIG. 1 at the initial tn. time |Ad|=0, the work of the rotational motion of the rotor equals zero. At the same time work Ae=max, the rotational force of the rotor associated with the electrical current in the windings of the motor, and the work is much greater in the process of the rotor acceleration than in the steady state mode, sometimes exceeding manifold. Then, according to the author's energy diagram, there occurs a transition of the exceeding part from the electrical energy set up after the acceleration or conversion into mechanical energy which is accumulated and then saved as a part of the rotor motion in the period of time tn. After this time the motor operates in the steady state mode of time tp in the presence of component |Ad|. The fact also proves that the law of conservation of mechanical energy (6) is observed and conversion of the exceeding part of work Ae—the rotational forces of the rotor associated with the electric current or the start-up part of the work, into the acceleration of the rotor occurs in advance so that |Ad| could further be used as the main work of the rotational motion of the rotor in the steady state mode. So, according to the author's energy diagram, in the period of time tp in the steady state or nominal mode of the motor two components operate simultaneously: the work component Ae—the rotational forces of the rotor associated with the electric current in the windings in the nominal mode, and |Ad|—the main component work constantly accumulated from the rotational motion of the rotor with mass m and inertia moment J which add up to the total work of the potential electromechanical machine.

In the sources of information (1)-(5) for the well-known methods |Ad|—the work component of the rotational motion of the rotor for operation of electrical motors is not inherently provided. Work |Ad| or power |Pd| of the motor, which are constantly present and do not disappear without a trace, are not presented. At the same time, the electric power meter of the energy consumed by the electric motor only measures the power component Pe equal to the truncated value tot.=(V3)U−I without component Pd. The electric power meter in the steady state mode does not measure the accumulated power component |Pd| of the electric motor's rotor motion in the steady state mode regardless of the fact that the component is constantly present and only due to the component the steady state operating mode is provided, according to the author's diagram in Fig.

The efficiency coefficient and effectiveness of the proposed method for operation of an electromechanical motor is supported by the presence of the main accumulated mechanical component |Ad|. The values are always higher than in the well-known motors according to sources (1)-(4) and method (5) as per GOST Standard.

In the case suggested by the author in expressions [1], [2], the laws of conservation of energy as well as the fundamental laws of Newtonian mechanics (7) are completely observed. Absolute values of work and power of the rotational motion of the rotor in [1]-[2] are taken since they are negative in direction, have a decelerated character and decreasing motion under the action of friction.

Equation [5.20] on p. 195 in (4) is based on scientific knowledge and a practical proof of existence of energy, work Ad, and categorically describes the physical process when “in the start-up period mechanical energy obtained under acceleration or when the rotational motion is accelerated beforehand is accumulated”. It is widely known that mechanical energy or work for rotational motion is only performed by angular rate and by way of inertia moment (distribution of mass about the axis of rotation). Section 4, “The principal law of rotational motion dynamics” on p. 78 ‘The example 1.M=J−dop/dt as the equation of a rotor's motion for a solid body’ in (6). ε=dop/dt is the acceleration of an electromechanical motor rotor in the start-up period of time. In the start-up period of time to the increase in kinetic energy of the rotor up to the constant value Ad in the steady state mode takes place. As a result, equation [5.20] on p. 195 in (4) only describes the start-up mode or start-up period of the electromechanical motor operation, where the right hand side of the equation shows electromagnetic torque or the start-up part of electric energy which is equivalently conversed into the storage or accumulated mechanical energy of the rotor. After the rotor's acceleration, the storage power can be “stored” as kinetic energy Ad=J−G²/2 constant in magnitude, which can produce work Ad.

In equation [5.20] on p. 195 in (4) the right hand side, as the start-up part of electric energy, can be measured. For that, the quantitative value of electric energy should be separately measured by a conventional electric power meter or counter as is showed in the information source (2) on p. 221 8-6 “Measurement of electric energy” consumed in the start-up period of time from the moment of voltage supply till the steady state mode after the rotor's acceleration is over, according to Fig of the diagram. The value of the start-up part of electric energy is consumed equivalently to the mechanical energy of the motor's rotor Ad, which is based on the “Law of conservation and transformation of energy” in the information source (6) p. 57 Section 1. “Energy” Chapter 3 “Work and mechanical energy” which, in its turn, is constantly quantitatively present as a component or is stored and act as the accumulated mechanical energy of the rotor in expression [1]. As a result, the material equivalent of the start-up part of electric energy is measured separately as Ae=V3−UT−5−tn/2—the area of a conventional triangle, where it is conversed into the energy of rotor's rotation by means of its acceleration in Fig of the diagram.

The physical ground and proof of storage or accumulation of mechanical energy are well-known from, for example, the information source (8). On p. 178 “. . . work performed by all forces exerted on a body is used to gain its kinetic energy . . . ” as well as for the rotor of the electric motor in the invention under consideration where, from expression [5.20] on p. 195 in (4), the work of electromagnetic forces in the start-up period is used to gain kinetic energy or to store and accumulate mechanical energy in the form of kinetic energy of the rotor of the electromechanical motor.

Then the accumulated energy Ad along with Ae according to the law of conservation of energy (6) produces total integrated value of physical work of the electromechanical motor in conversion of electrical energy into mechanical energy [1].

The feature “store and apply the accumulated mechanical energy”, “operate it directly in the steady state mode” is utterly definitive, where the rotor of the motor with target mass m and the inertia moment J is the material object, and the accumulated mechanical energy in the form of the ultimate or calculated energy obtained in the period of the rotor's acceleration by means of equivalent decrease of the start-up part of electrical energy down to the nominal is the material means of energy “storage”.

The feature “perform a different value of the work component from the electric current in the steady state nominal mode of the motor” Ae exists objectively according to the information sources (1)-(4). This part of energy, work is measured by the conventional method with well-known devices and electric energy meters, which is mentioned above.

The feature “total mechanical work is performed jointly and obtained in amounts equal to the sum of the component values” as in expression [1] or [2] is based on objectively existing, separately measured values Ad and Ae, the material means described above and presented for each of the objectively existing features basing on the fundamental law of conservation and transformation of energy.

### BRIEF DESCRIPTION OF THE DRAWING

FIG. 1 shows the energy diagram prepared by the inventor; FIG. 1 graphically presents the suggested method for operation of the electromechanical motor and the motor. The diagram in Fig has three working areas divided on top according to the types of energy, E—electrical, EM in the middle—electromechanical, and M—mechanical. The left hand side shows three periods of time or operating modes of the motor, tn. is the start-up time, tp. is the steady state mode time, U. is the time of the motor stopping after it is disconnected from the electrical network. For each period of time there are intervals of work values on the right hand side of the diagram: the start-up period corresponds with the acceleration of the rotor's mass rotation to the steady state work of the energy of motion from the component Ad=0 to Ad=max, from zero to maximum, while the total balance of energy Atot.=|Ad|+Ae is provided.

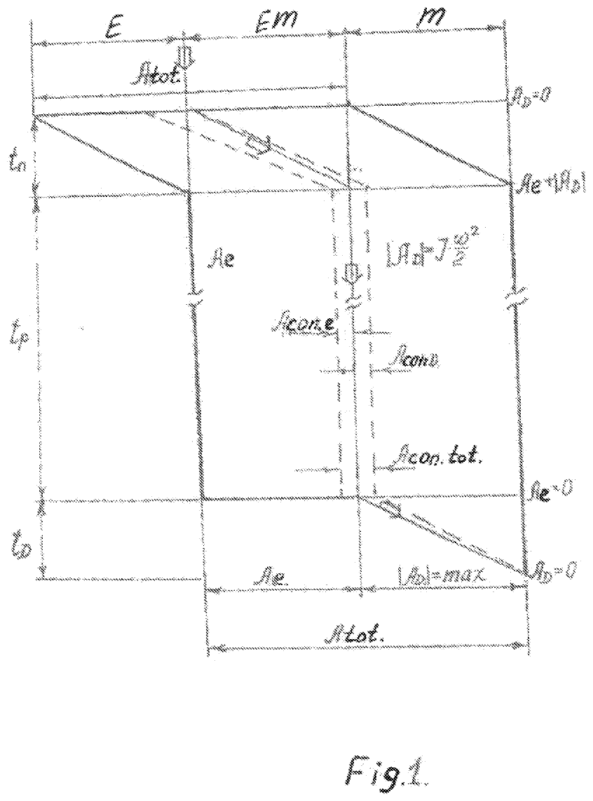

Then, in the steady state mode tp. work also equals to the total value Atot.=|Ad|+Ae and after isolating voltage ta. work is determined in the interval of the component from Ad=max to Ad=0. The bottom part of the diagram shows equality [1] as a sum of works of the method suggested. In the center of the diagram from top to bottom a bidirectional arrow shows losses which have an impact on each of the components Ae and |Ad| depending in the periods of time and operating modes. Initially, in the start-up period tn. the losses depend on work of great electric starter currents while mechanical friction equals zero; in the end, in the steady state mode the losses balance and are evenly distributed between each of the components, electromechanical Ae. and mechanical work |Ad|of the rotor's motion. After isolating the voltage supplying the electromechanical motor, there only are mechanical losses which decrease with the decrease in the velocity of the rotor's motion by inertia, which is showed in the bottom part of the diagram. The dash line in the middle from top to bottom limits and shows losses which, separately and in total, are presented by arrows where Acon.tot.=Acon.e+Acon.d. In the mechanical area of work on the diagram mathematical formula |Ad|=J−co²/2 is showed and it is obvious that this is the area of kinetic energy of the rotor's motion, the work is constantly present after conversion from purely electrical energy from the area in period tn. of the rotor's start-up. At the top of the energy diagram at the start of the start-up time tn. total work Atot has an electric character and content and during the rotor's acceleration it decreases and is converted into mechanical work of the rotor's rotational motion moving towards the right hand mechanical side of the diagram. The diagram graphically presents the scale of the components of electromechanical and mechanical parts of work of the suggested method for operation of the electromechanical motor, which is two times greater than in the known methods according to sources (2) p. 267 of the energy diagram, and (3), (4).

2. Motor. The technical result is achieved by the electromechanical motor with a stator and a rotor with the target mass and inertia moment rotating in the stator and placed on supports with lids. It can accumulate mechanical energy conversed beforehand as a result of the accelerated rotation of the rotor's masses in the start-up period of time and then stored and acting as the main component in the steady state mode of the motor, as well as with the quantitative component of work from electrical energy rotating the rotor in the steady state mode with the quantitative balance of total work equal to the sum of the component values determined by expression [1].

To produce the new electromechanical motor unknown before, for it to operate without breaking the fundamental laws of Newtonian mechanics and the law of conservation of energy and in accordance with International units, the conversion of electrical energy into mechanical one by means of interaction of conductors with electric current and magnetic fields in the motor includes its production with a rotor with mass m and inertia moment J, and the potential to accumulate mechanical energy in numerical terms and obtaining total work or power from two components according to mathematical expressions [1] and [2]. The author's energy diagram graphically shows a possible existence of a rotor construction which moves having accumulated a quantitative value of mechanical energy in the form of kinetic energy after conversion from electrical energy in the start-up time tn.; then, it is constantly present and perform total work or power along with the electric component according to mathematical expressions [1], [2].

### DETAILED DESCRIPTION OF THE PREFERRED EMBODIMENTS

The proposed electromechanical motor with a stator and a rotor rotating in it with mass m and inertia moment J is produced in such a way that it has a potential to accumulate mechanical energy conversed beforehand as a result of accelerated rotation of the rotor's masses in the start-up period of time and then stored and effective value as the main component in the steady state mode, as well as with the quantitative component of work from electrical energy rotating the rotor in the steady state mode with the balance of total or complete work equal to the sum of these component values, determined by expression [1].

The realization of the proposed method for operation of the electromechanical motor is carried out as follow: a rotor with mass m and inertia moment J on the supports of rotation is taken and rotated in the stator; at that, in the start-up period of time mechanical energy is accumulated, which, in its turn, is obtained by accelerating the rotor or accelerating its rotational motion; then, the accumulated mechanical energy is stored and used as the main component, it is used in the steady state mode. Besides, another value of work component is performed from electric current in the steady state nominal mode of the motor, while total mechanical work is performed and obtained in the amount equal to the sum of the component values determined by mathematical expression [1].

Some methods before the proposed invention priority date are known to make it possible to realize the method suggested. The materials are based, for example, on the information on the widely used motors of AIR-225 brand with the nominal power Pn-55kW, 3000 rpm or rotor's velocity 314 s¹, voltage supply 380 V, ratio of starter current to nominal current 1p/1n=5, mass m=320 kg. For example, let us consider the motor rotor with mass 120 kg and the diameter of its working part 250 mm.

To start up the AIR-225 electric motor high starter currents are needed to accelerate the rotor with mass m=120 kg and inertia moment J=m−r²/2=120 kg−0.125²/2m²=0.9375 kg/m². As a result, there is a start-up mode with the start-up period of time to of electric current, and this corresponds to the start-up mode of the drawings of the application in Fig on the author's energy diagram. After the start-up mode is over the electric motor goes on operating in the steady state mode with the involvement of the main component Ad=(J−CD²)/2, which corresponds to the operating mode tp. of the drawings of the application according to Fig. As a result, in the start-up mode period accumulation of mechanical energy of the rotor to the expected value is provided. Then, after the start-up mode is over the obtained mechanical energy with the total quantity of components Ad and Ae determined by mathematical expression [1] according to the law of conservation of mechanical energy is applied.

Since the well-known electric motors, such as AIR-225, do not have the start-up part of electrical energy conversed into mechanical energy of the rotor in numerical terms in the steady state mode, therefore, electrical energy in the steady state mode “has an immediate impact on mechanical friction or resistance (load)” without the agency of quantitative accumulated energy of the motor rotor. This is objectively impossible and contradicts the law of conservation of energy.

The application of the accumulated mechanical energy is carried out by scientifically proven methods and is confirmed by references to the prior art. Mechanical energy or work is known to be performed by means of inertia moment (the distribution of mass about the axis of rotation) for rotational motion.

The value of the rotor's accumulated mechanical energy with the known motor is found by the formula Ad=(^{r.}ω²)/2=(0.9375 kg/m²⁻³¹⁴ s²)/2=46216.875 J(W−s). Here we can compare some rated values of power of AIR-225, such as 55 kW or 55000 W, with the power of the rotor's developed kinetic energy Pd=46216 W or work Ad=46216 J(W−s). In a first approximation, work Ae in the steady state mode amounts to not more than 55% (54.34%), without considering the losses and load, from Atot.=55000 Ws+46216 Ws=101216 Ws(J) by expression [1] or 101216 W by expression [2]. According to the law of conservation of mechanical energy, the start-up part of electrical energy of AIR-225 electric motor was converted into accumulated mechanical energy of the rotor Ad or Pd. Then the accumulated energy along with Ae, according to the law of conservation of energy (6), performs total quantity of physical work of the electromechanical motor according to conversion of electrical energy into mechanical energy [1].

“Application of the accumulated mechanical energy and its immediate operation in the steady state mode” is categorically distributed between all types of work: energy of mechanical friction and resistance to the rotor's motion as well as the intensity of load in the case of application of the motor as a mechanism drive—the motor's rotor, initially. In science and in practice there are no facts to prove quantitative and qualitative effect of electromagnetic forces, omitting mechanical energy of the motor's rotor, or the impact of the forces such as, for example, electromagnetic moment directly on mechanical energy of friction, resistance and/or load.

Comparison of conventionally identical electromechanical motors AIR-225 with different quantitative values of accumulated mechanical energy of rotors can be an example of a practical and optimal realization of the invention claimed in n.1 and n.2 proving its applicability. From mathematical expression Ad=J−CQ²/2 or as power Pd=J−co²/2−t it can, for example, be presented ω=V(2A J). If mechanical loads ΔA equal in value are exerted on the output shaft of the rotor, they act directly through the accumulated mechanical components from expression [1]; at that the motor with less accumulated mechanical energy reacts to a greater degree and spends the kinetic energy of the rotor by decreasing angular rate Δω since it is inversely proportional to inertia moment under the square root. Therefore, to set up a nominal mode for the electromechanical motor with high values of inertia moment a lower quantitative value of electrical component of energy Ae from expression [1] is needed through refilling the “consumption” of angular rate Aw of the rotor. Thus, the greater the component of accumulated mechanical energy of the rotor is, the less amount of electrical energy is needed to perform the same amount of work as a part of expression [1] or [2].

Since the well-known electric motors (1)-(4) and, for example, AIR-225 do not have the start-up part of electrical energy or any equivalent mechanical energy in numerical terms in the steady state mode, then the fact proves that the existing methods for operation of electric motors “contradict the law of conservation of energy”. The statement is ultimately objective and explicit, scientific and technically proved in the form of the component of quantitative and measurable mechanical energy or work Ad. Therefore, the proposed author's invention of the method for operation of electromechanical motors and the device for their realization are the only ones that do not contradict the definition and essence of mechanical work and reflect the application of the existing laws of Newtonian mechanics (7).

The proposed invention of the method for operation of an electrical motor and motor are novel, non-obvious and industrially applicable; they also meet the criteria established by the current legislation.

### Information Sources

1. F. A. Brockhaus—I. A. Efron, “Encyclopedic Dictionary”, 1890, reprint on the occasion of the 100th anniversary of the 1st publication 1890-1990, “Terra”—TERRA, VOL. 80, 1994, p. 469, “Electric motors”.
2. V. S. Popov, S. A. Nikolaev “General electric engineering with fundamentals of electronics”, Second edition, revised and enlarged, “Energiya”, Moscow, 1976, pp. 267-271.
3. A. E. Zorokhovich, V. K. Kalinin, “Electric engineering with fundamentals of industrial electronics”, Second edition, revised and enlarged, “Vysshaya Shkola”, Moscow, 1975, p. 213, etc.
4. I. P. Kopylov, B. K. Klyukov, V. P. Morozkin, B. F. Tokarev, “Electrical machine design”, textbook 4th edition, revised and enlarged, approved by Ministry of Education of RF for university majors in electrical mechanics and electrical power, Moscow, 2011.
5. GOST 25941-83, “Methods for determination of losses and electrical machine efficiency”.
6. B. M. Yavorsky and A. A. Dettlaff, “Guide to physics”, for engineers and college students, 4^{th} edition, revised and enlarged, “Nauka” Publishers, Chief editorial board of physical-mathematical literature, Moscow, 1968.
7. I. Newton, “Mathematical Principles of Natural Philosophy”, translated from Latin with comments by A. N. Krylov, Leningrad, Academy of Sciences of USSR, 1936.
8. I. V. Savelyev “General Physics”, in five volumes, Volume 1, “Mechanics”, Moscow, “Astrel—AST”, 2005, “Kinetic energy of a rotating solid body”, pp. 177-181.

What is claimed is:

1. A method for operation of an electromechanical motor, including: conversion of electrical energy into mechanical energy by means of interaction between conductors or windings with electric current with magnetic fields between a immobile stator and a rotating rotor with a target mass and an inertia moment on supports of rotation, wherein in a start-up period of time the mechanical energy obtained when accelerating the rotor or its rotational motion is accumulated; then the mechanical energy is stored quantitatively and applied as a main work component; the mechanical energy is operated in the steady state mode, and another value of work component is performed from an electric current in a steady state nominal mode of the electromechanical motor, while a total mechanical work is performed jointly and is obtained in an amount equal to a sum of the component values determined by the mathematical expression
Atot=+Ae; [1],
where Atot is the total mechanical quantitative work in conversion of electrical energy into mechanical energy of the electromechanical motor; |Ad| is the component value of work from the accumulated energy of the rotational motion of the rotor; Ae is the component value of work from electric current in the steady state mode of the motor.

2. A motor, including a stator and a moving rotor, which is moving due to an interaction of an electric current with magnetic fields, the rotor with a target mass and an inertia moment on supports of its rotation, wherein a motor accumulates mechanical energy conversed beforehand as a result of an accelerated motion of the rotor's mass in a start-up period of time and then stored and an effective value as the main component of work in a steady state mode of the motor, as well as with a quantitative component of work from electrical energy rotating the rotor in the steady state mode with a quantitative balance of a total work equal to a sum of component values determined by an expression [1].
